(19) United States
(12) Patent Application Publication
(10) Pub. No.: US 2016/0041760 A1
(43) Pub. Date: Feb. 11, 2016

(54) Multi-Level Cell Flash Memory Control Mechanisms

(71) Applicant: International Business Machines Corporation, Armonk, NY (US)

(72) Inventors: Jente B. Kuang, Austin, TX (US); Janani Mukundan, Ithaca, NY (US); Gi-Joon Nam, Austin, TX (US); Gary A. Tressler, Sandy Hook, CT (US)

(21) Appl. No.: 14/454,835

(22) Filed: Aug. 8, 2014

(51) Int. Cl. G06F 3/06

(52) U.S. Cl. CPC G06F 3/0604; G06F 3/0634; G06F 3/064; G06F 3/0653; G06F 3/0658; G06F 3/0679

(57) ABSTRACT

Mechanisms are provided, in multi-layer cell (MLC) flash memory device comprising a MLC flash memory and a controller, for controlling an operation of the MLC flash memory device. The controller controls accesses to a block of memory pages in the MLC flash memory to be performed to the full block of memory pages in a MLC mode of operation. The controller determines whether a MLC retirement threshold has been met or exceeded by an operating characteristic of the block of memory pages. The controller, in response to detecting that the operating characteristic of the block of memory pages has met or exceeded the MLC retirement threshold, switches an operating mode associated with the block of memory pages from the MLC mode of operation to a single-level cell (SLC) mode of operation. The controller enforces the SLC mode of operation when performing access operations to the block of memory pages.

### BACKGROUND

The present application relates generally to an improved multi-level cell (MLC) flash memory system and device, and more specifically to mechanisms for controlling the operation of such MLC flash memory systems/devices to exploit bit error rates and latency differences between component pages within blocks of the MLC flash memory systems/devices.

Flash memory is an electronic non-volatile computer storage medium that can be electrically erased and reprogrammed. Flash memory was developed from electrically erasable programmable read only memory (EEPROM) devices. There are two primary types of flash memory, NAND and NOR type flash memories, named after the logic gates that the cells of the flash memory emulate. Where EEPROMs had to be completely erased before being re-written, NAND type flash memories may be written and read in blocks (or pages) which are generally much smaller than the entire device. NAND type flash memories are used in main memories, memory cards, Universal Serial Bus (USB) flash drives, solid-state drives (SSDs), and the like. NOR type flash memories are generally used as replacements for older EEPROMs and as an alternative to read only memories (ROMs) in some applications.

Flash memory devices store data in individual memory cells which are made up of floating-gate transistors. Traditionally, cells of a flash memory device had two possible states, e.g., high or low, programmed or erased, 1 or 0, or the like, and thus, could only store a single bit per cell. These are referred to as single-level cell (SLC) flash memories. SLC flash memory has the advantage of relatively fast write speeds, low power consumption, and high cell endurance. However, because SLC flash memories only store a single bit per cell, SLC flash memories cost more per megabyte of storage to manufacture. SLC flash memories are used in high-performance memory cards due to their relative faster transfer speeds and longer life.

Multi-level cell (MLC) flash memories are memory devices capable of storing more than a single bit of information in each cell. In MLC flash memories, multiple levels are provided per cell to allow more bits to be stored using the same number of transistors. Most MLC flash memories, contrary to the two states permitted in SLC flash memories, provide four possible states per cell so that they may store two bits of information per cell. This reduces the amount of margin separating the states and results in a higher possibility of errors. However, the cost of MLC flash memories is lower since a lower number of hardware elements are required per megabyte of storage capacity. Stated another way, a MCL flash memory can store twice as much data as a SLC flash memory and thus, a lower number are necessary for most applications.

A further category of MLC flash memories has been developed that can support eight possible states per cell, thereby allowing each cell to store up to three bits of information per cell. Flash memories that utilize such cells are referred to as triple level cell (TLC) flash memories.

### SUMMARY

In one illustrative embodiment, a method, in multi-layer cell (MLC) flash memory device comprising a MLC flash memory and a controller, for controlling an operation of the MLC flash memory device is provided. The method comprises controlling, by the controller, accesses to a block of memory pages in the MLC flash memory to be performed to the full block of memory pages in a MLC mode of operation. The method further comprises determining, by the controller, whether a MLC retirement threshold has been met or exceeded by an operating characteristic of the block of memory pages. Moreover, the method comprises switching, by the controller, in response to detecting that the operating characteristic of the block of memory pages has met or exceeded the MLC retirement threshold, an operating mode associated with the block of memory pages from the MLC mode of operation to a single-level cell (SLC) mode of operation in which a sub-set of pages of the block of memory pages are utilized for access operations. In addition, the method comprises controlling, by the controller, access operations to the block of memory pages in accordance with the SLC mode of operation in response to switching the operating mode of the block of memory pages from the MLC mode of operation to the SLC mode of operation.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE SEVERAL VIEWS OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1A is an example diagram of the organization of a MLC flash memory device;

FIG. 1B illustrates the four states that a cell may have;

FIG. 1C illustrates different cell distributions for LSB programming;

FIG. 1D illustrates four different distributions for MSB programming;

FIG. 2 illustrates another type of MLC flash memory device in which three bits are stored per cell of memory, referred to as a three-level cell (TLC) flash memory device;

FIG. 3 is an example plot of read/write latency of MSB and LSB pages of a block of a MLC flash memory device illustrating one such observation;

FIG. 4 illustrates a plot of the number of bits corrected over a number of erase/program/read cycles for two LSB and two MSB pages of a block of a MLC flash memory device;

FIG. 5 illustrates a plot of a frequency of page failures for various pages in a block of a MLC flash memory device;

FIG. 6 illustrates one illustrative embodiment for exploiting the difference in bit error rates of least significant and most significant bit pages of a block of a multi-level cell (MLC) flash memory;

FIG. 7 illustrates an example embodiment in which the page utilization for a MLC flash memory block is dependent upon physical location of the pages;

FIG. 8 illustrates another illustrative embodiment in which pages of a MLC flash memory block are combined to generate high performance blocks for high performance applications;

FIGS. 9A and 9B illustrate example pseudo-code for implementing a health function and address translation for writes for an MLC flash memory device;

FIGS. 10A and 10B illustrate example pseudo-code for implementing a similar health function and address translation for writes for a TLC flash memory; device;

FIG. 11 is an example block diagram of a flash memory device implementing the flash memory controller and corresponding logic in accordance with one or more of the illustrative embodiments previously described above;

FIG. 12 is a flowchart outlining an example operation for performing multi-stage retirement of a block of flash memory in accordance with one illustrative embodiment; and

FIG. 13 is a flowchart outlining an example operation for controlling the operation of a flash memory device in response to a garbage collection request or power savings request in accordance with one illustrative embodiment.

### DETAILED DESCRIPTION

The illustrative embodiments provide mechanisms for controlling the operation of such Multi-Level Cell (MLC) flash memory systems/devices to exploit bit error rates and latency differences between component pages within blocks of the MLC flash memory systems/devices. The mechanisms of the illustrative embodiments provide a low overhead scheme for achieving an extended lifetime for MLC flash memory systems/devices that is transparent to top level software of the host system. That is, only the address translation performed by the MLC flash memory system/device controller is affected during operation requiring hardware and/or software changes in the logic of the controller, and utilizing a single bit per block to monitor the retirement state of the blocks of the MCL flash memory system/device, as described hereafter.

It should be appreciated that, within the context of this description, the term “block” refers to a smallest unit of an erase operation performed on a flash memory system/device. A block is made up of multiple flash memory pages. For example, a block may be comprised of 64 or 128 pages of flash memory. Multiple blocks make up a flash plane while one or more planes make up a flash die (or bank). In one implementation of a MLC flash memory system/device in which the illustrative embodiments are implemented, the pages of a block comprise least significant bit (LSB) and most significant bit (MSB) page pairs. The LSB and MSB page pairs share a same word line in the flash memory array and have consecutive addresses. Thus, page 0 (LSB) and page 1 (MSB) share the same word line, for example. It should be noted that rather than even numbered pages being LSB and odd numbered pages being MSB, in some implementations this may be reversed.

In some illustrative embodiments, the mechanisms of the illustrative embodiments operate to control read/writing of data to blocks of a MLC flash memory system/device so as to switch from a first mode of operation to a second mode of operation in response to a retirement threshold being met. More specifically, in some illustrative embodiments, a MLC retirement threshold is set indicating a number of erasures that the block may perform while operating in a MLC mode of operation. Once this MLC retirement threshold is met or exceeded, reading/writing to the block is switched to a Single-Level Cell (SLC) mode of operation and the block is marked, using the 1-bit per block metadata, as being semi-retired. A semi-retired block, in the context of this description, refers to a block of memory cells in a MLC flash memory system/device in which only a predetermined subset of the memory cells of the block are utilized for reading/writing while other subsets of the memory cells are no longer utilized, i.e. they are retired. Thus, the block as a whole is only semi-retired since some of the memory cells are still utilized while others are not.

It should be appreciated that the MLC flash memory system/device comprises a large number of blocks and the switching from MLC to SLC mode (or semi-retired mode) of operation may be applied to only a sub-set, or even just one, block within the plurality of blocks of the MLC flash memory system/device. In most implementations, it is expected that the sub-set of blocks that are switched to an SLC mode of operation will be significantly smaller than the number of blocks operating in a full MLC mode of operation and thus, the MLC flash memory system/device may still be considered a MLC system/device with only a sub-set of blocks operating in an SLC mode of operation.

For a semi-retired block in an MLC flash memory system/device (hereafter referred to as an MLC device for simplicity), the reading/writing of data utilizes only a predetermined subset of the memory cells in the block. In one illustrative embodiment, if page-based mapping is utilized by the MLC device controller to map logical addresses to physical pages of memory, only the least significant bit (LSB) pages of the block are utilized and the most significant bit (MSB) pages are not utilized. In another illustrative embodiment, if block-based mapping is utilized by the MLC device controller, pairs of LSB pages of two semi-retired blocks are combined to form a super block and the LSB pages of the super block are utilized. In either embodiment, the semi-retired block of memory of the MLC device is still utilized in the SLC mode of operation until a SLC retirement threshold is reached at which point the block is added to a bad block list for the MLC device and is no longer utilized to read/write data.

In another illustrative embodiment, when a threshold is reached, such as the MLC retirement threshold or another set threshold, or when a triggering event is detected, e.g., a number of errors that have been captured reaches a trigger value, the MLC device controller switches from a healthy block mode of operation to a semi-retired block mode of operation in which pages of the MLC device are utilized according to their physical location within the block. That is, rather than selecting pages to be utilized in a semi-retired block mode of operation based on whether or not they are being used as LSB pages or MSB pages, the mechanisms of this illustrative embodiment select pages to be utilized based on their physical location within the block. For example, in one illustrative embodiment, only an “upper half” of the block is utilized during a semi-retired block mode of operation whereas a “lower half” of the block is not utilized during semi-retired block mode of operation and are effectively retired. In such a case, the upper half of the block continues to operate with reads/writes being performed in a SLC mode of operation. It should be noted that the terms upper and lower half are used to represent two sub-sections of the block, but in some configurations these halves may be switched. Moreover, additional sub-sections may be considered as well rather than utilizing only halves of the block, e.g., 3 or 4 sub-sections may be considered with multiple thresholds being used to periodically retire portions of a block.

In addition, in some illustrative embodiments, mechanisms are provided to exploit the difference in latencies between LSB pages and MSB pages of a block. In such illustrative embodiments, if the MLC device controller utilizes page based mapping, high performance applications read/write from LSB pages that are determined to have less latency, whereas low performance applications read/write from MSB pages. If the MLC device controller utilizes block based mapping, LSB pages may be combined from two or more blocks to create a high performance block for use by high performance applications while MSB pages of these two or more blocks may be combined to create a low performance block for low performance applications.

In some illustrative embodiments, mechanisms are provided to improve garbage collection on MLC devices. In such illustrative embodiments, valid pages of full blocks of memory identified during garbage collection are moved to LSB pages of semi-retired blocks. In this way, the full block from which the valid pages are moved may be garbage collected and reused for storage of data. This improves performance of the garbage collection operation since writing only to semi-retired block LSB pages during garbage collection is faster than writing to MSB pages, as discussed in more detail hereafter.

In still further illustrative embodiments, power management mechanisms may be employed to switch the MLC device controller from a full MLC mode of operation to a semi-retired mode of operation or SLC mode of operation in which only the LSB pages of blocks of memory are utilized. That is, if the system needs to enter a power saving mode of operation, this information may be relayed to the MLC device controller which may then temporarily set the metadata for the blocks of the MLC device to a semi-retired state. As a result, at least temporarily, reads/writes to blocks of memory in the MLC device occur only with respect to the LSB pages, which are determined to require less power to access than the MSB pages. If the system exits the power saving mode of operation, this information may be relayed to the MLC device controller which may then re-set the metadata for the blocks of the MLC device to be in full MLC mode of operation and thereby return the MLC device to full MLC operational status.

These and other features and advantages of the illustrative embodiments will be described in greater detail hereafter. However, before beginning a more detailed discussion of the various aspects of the illustrative embodiments, it should first be appreciated that throughout this description the term “mechanism” will be used to refer to elements of the present invention that perform various operations, functions, and the like. A “mechanism,” as the term is used herein, may be an implementation of the functions or aspects of the illustrative embodiments in the form of an apparatus, a procedure, or a computer program product. In the case of a procedure, the procedure is implemented by one or more devices, apparatus, computers, data processing systems, or the like. In the case of a computer program product, the logic represented by computer code or instructions embodied in or on the computer program product is executed by one or more hardware devices in order to implement the functionality or perform the operations associated with the specific “mechanism.” Thus, the mechanisms described herein may be implemented as specialized hardware, software executing on general purpose hardware, software instructions stored on a medium such that the instructions are readily executable by specialized or general purpose hardware, a procedure or method for executing the functions, or a combination of any of the above.

The present description and claims may make use of the terms “a”, “at least one of”, and “one or more of” with regard to particular features and elements of the illustrative embodiments. It should be appreciated that these terms and phrases are intended to state that there is at least one of the particular feature or element present in the particular illustrative embodiment, but that more than one can also be present. That is, these terms/phrases are not intended to limit the description or claims to a single feature/element being present or require that a plurality of such features/elements be present. To the contrary, these terms/phrases only require at least a single feature/element with the possibility of a plurality of such features/elements being within the scope of the description and claims.

In addition, it should be appreciated that the following description uses a plurality of various examples for various elements of the illustrative embodiments to further illustrate example implementations of the illustrative embodiments and to aid in the understanding of the mechanisms of the illustrative embodiments. These examples intended to be non-limiting and are not exhaustive of the various possibilities for implementing the mechanisms of the illustrative embodiments. It will be apparent to those of ordinary skill in the art in view of the present description that there are many other alternative implementations for these various elements that may be utilized in addition to, or in replacement of, the examples provided herein without departing from the spirit and scope of the present invention.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Before discussing the improvements made by the illustrative embodiments, it is best to first have an understanding of the observations that lead to the devising of these illustrative embodiments and improvements. In order to illustrate the problems with known multi-level cell (MLC) flash memory devices and the observations of their behavior that lead to the devising of the illustrative embodiments, one must first understand the operation of a MLC flash memory device in general.

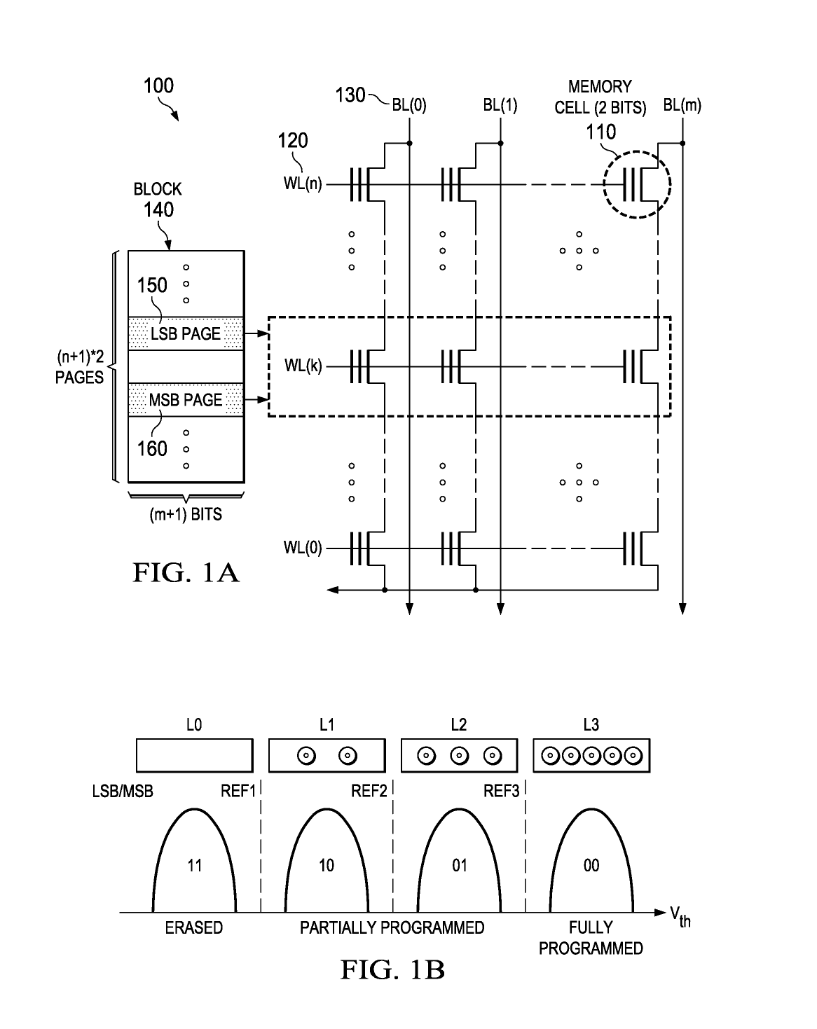

FIG. 1A is an example diagram of the organization of a MLC flash memory device. The particular MLC flash memory device shown in FIG. 1 is of an all bit line (ABL) architecture, meaning that all of the bit lines connected to page buffers are sensed simultaneously.

As shown in FIG. 1A, the MLC flash memory device 100 is comprised of a plurality of cells 110 arranged as word lines (WLs) 120 (shown as rows) and having bitlines (BLs) 130 (shown as columns) to allow addressing the individual cells. That is, the intersection of a word line 120 and bitline 130 constitutes the address of the cell 110. There are n+1 word lines 120, i.e. WL(0) to WL(n), and m+1 bitlines 130, i.e. BL(0) to BL(m)

The MLC flash memory device 100 is further logically configured as blocks of memory 140. Each block of memory 140 comprises one or more pages of memory 150, 160. In a MLC flash memory device 100, certain pages 150 of the block 140 store the least significant bits of the word lines 120 while other pages 160 of the block store the most significant bits of the word lines 120. Thus, for a single block of memory 140, there are (n+1)*2 pages 150, 160, i.e. 2 pages for each word line—one to store the least significant bits (LSBs) 150 and another to store the most significant bits (MSBs) 160 in the word line 120. Each page has m+1 bits, i.e. a number of bits equal to the number of cells in the word line 120. Thus, the size of the memory block is (n+1)*(m+1)*2 in this case.

In an MLC flash memory device 100, each cell stores more than one bit of data. In the depicted example, the cells 110 store 2 bits of data and thus, have four states. FIG. 1B illustrates the four states that a cell 110 may have. As shown in FIG. 1B, the cell 110 may have various voltage states relative to different reference voltages REF1-REF3 for the different threshold voltages that the cell 110 may have. For example, if the cell 110 is in stated L1, then the threshold voltage for the cell 110 is REF2. L0-L3 depict the relative number of electrons that will be stored at each threshold voltage level. These voltage states include an erased stated (11), one of two partially programmed states (10 or 01), or a fully programmed state (00).

With cells that are able to store more than one bit of data, such as the MLC flash memory device 100 cells 110 in FIG. 1A, programming of the cells requires more sophisticated sensing and voltage manipulations due to the multiple states that the cells 110 may have. For example, LSB programming in cells 110 of a word line 120 only requires two different cell distributes as shown in FIG. 1C. That is, with LSB cells, the cell need only be brought to a voltage other than erased (11) to indicate that the cell has been programmed since the LSB cells can only store one of two values, i.e. either a “1” or a “0.” MSB programming, on the other hand may take any of four different distributions, since MSB cells can store multiple values, and thus, requires a much more sophisticated sensing of the voltage distributions, as shown in FIG. 1D. As a result, the MSB programming exhibits a longer latency than the LSB programming.

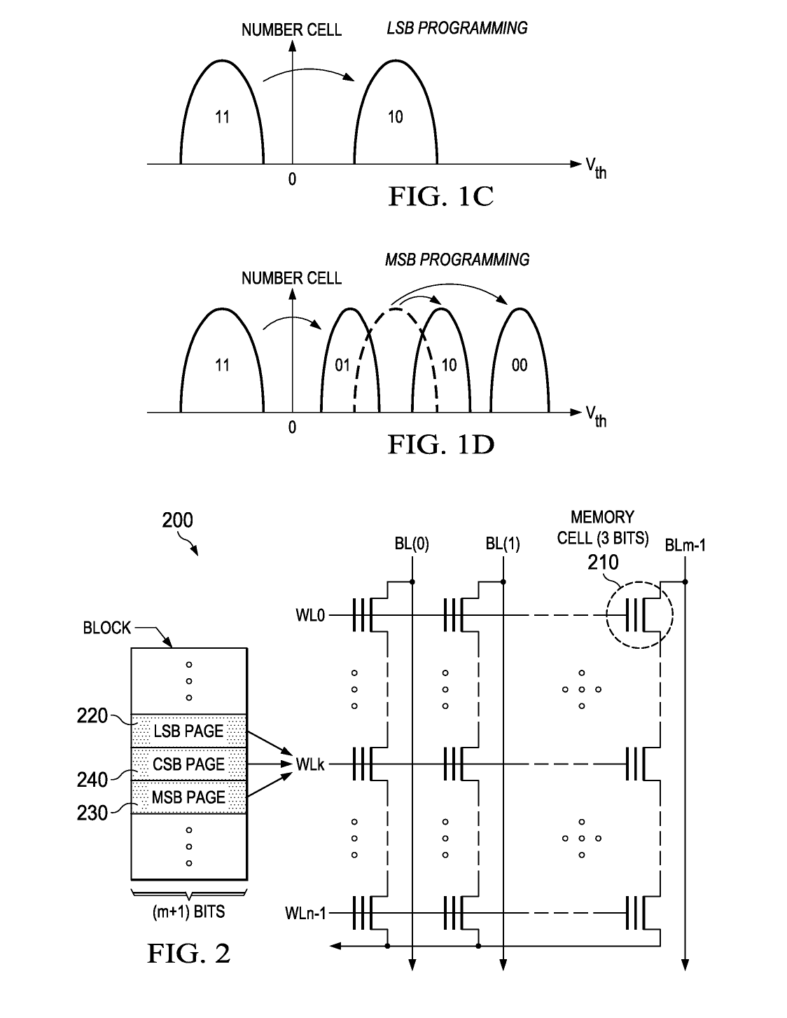

FIG. 2 illustrates another type of MLC flash memory device in which three bits are stored per cell of memory, referred to as a three-level cell (TLC) flash memory device. The TLC flash memory device 200 operates in a similar manner to that of the MLC flash memory of FIG. 1A with the exception that each cell 210 is capable of storing 3 bits and has 8 possible voltage distribution states. Moreover, in addition to the LSB page 220 and MSB page 230, the bits in the word lines of the TLC flash memory device 200 include center significant bits (CSBs) and corresponding CSB pages 240. As a result, a TLC flash memory device 200 is organized into blocks with each block having LSB, CSB, and MSB pages 220-240. Thus, this architecture has n word lines (0 to n−1), m bitlines (0 to m−1), can store 3 bits per cell, and has n*3 pages per block of memory.

As will be described hereafter, the mechanisms of the illustrative embodiments may be extended to TLC flash memory devices as well as the MLC flash memory devices. For ease of explanation, the following description will primarily focus on the implementation of the mechanisms of the illustrative embodiments to MLC flash memory devices having 2 bits per cell. However, it will be apparent to those of ordinary skill in the art, in view of a reading of the present description, that these mechanisms may be also be utilized with other types of MLC flash memory devices, such as TLC flash memory devices, without departing from the spirit and scope of the present invention.

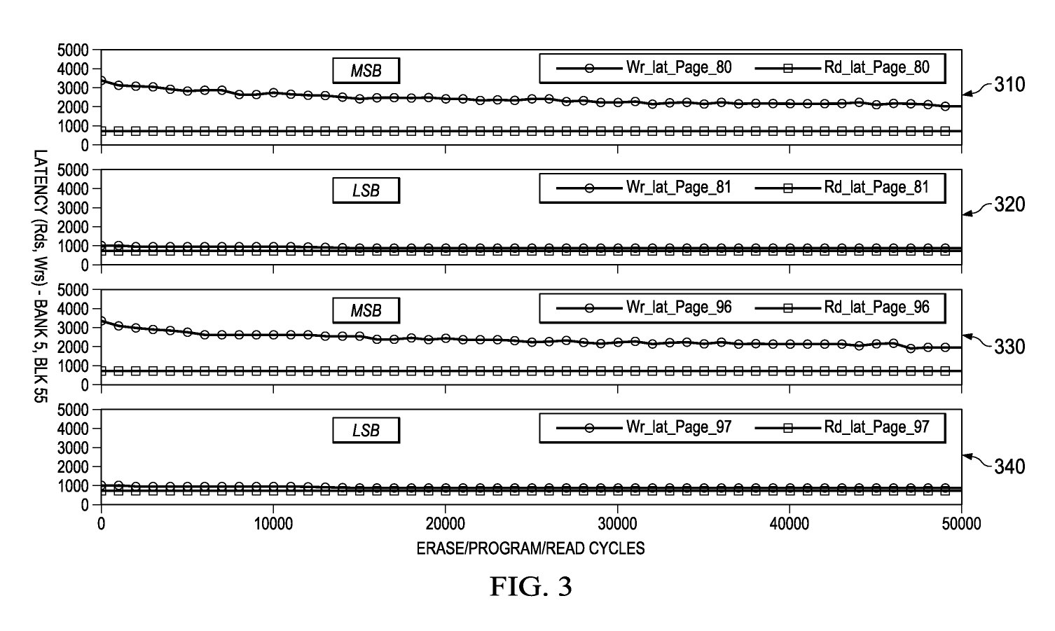

Various observations of the operation of the LSB and MSB pages of a MLC flash memory device have been made and are an impetus for the implementation of the mechanisms of the illustrative embodiments. FIG. 3 is an example plot of read/write latency of MSB and LSB pages of a block of a MLC flash memory device illustrating one such observation. It should be noted that the units for the X-axis in FIG. 3 correspond to the number of times a block has been erased while the units for the Y-axis represent microseconds of latency.

As shown in FIG. 3, the plot 310 represents the read/write latency of a first MSB page of a MLC flash memory device while plot 330 represents the read/write latency of a second MSB page of the MLC flash memory device. Plots 320 and 340 represent latency of reads/writes for two LSB pages of the MLC flash memory device. It can be seen from FIG. 3 that, while the latency for reads is approximately the same for both MSB pages and LSB pages, there is a greater latency for MSB pages than LSB pages when performing writes to these pages. In other words, writes to MSB pages are slower (have increased latency) than writes to LSB pages.

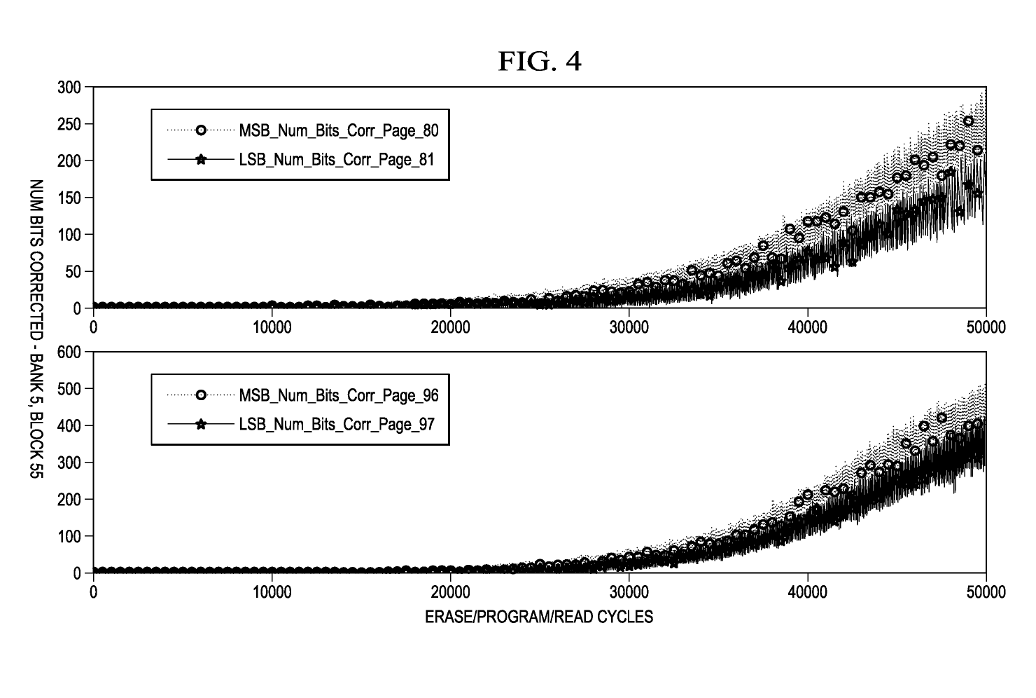

FIG. 4 illustrates a plot of the number of bits corrected over a number of erase/program/read cycles for two LSB and two MSB pages of a block of a MLC flash memory device. These plots illustrates that, while LSB and MSB pages follow a similar trend and have greater bit error rates at higher erase/program/read cycles, the bit error rate is always larger for MSB pages than for LSB pages. Thus, in addition to having slower write operations for MSB pages, the MSB pages also experience greater bit error rates (BERs).

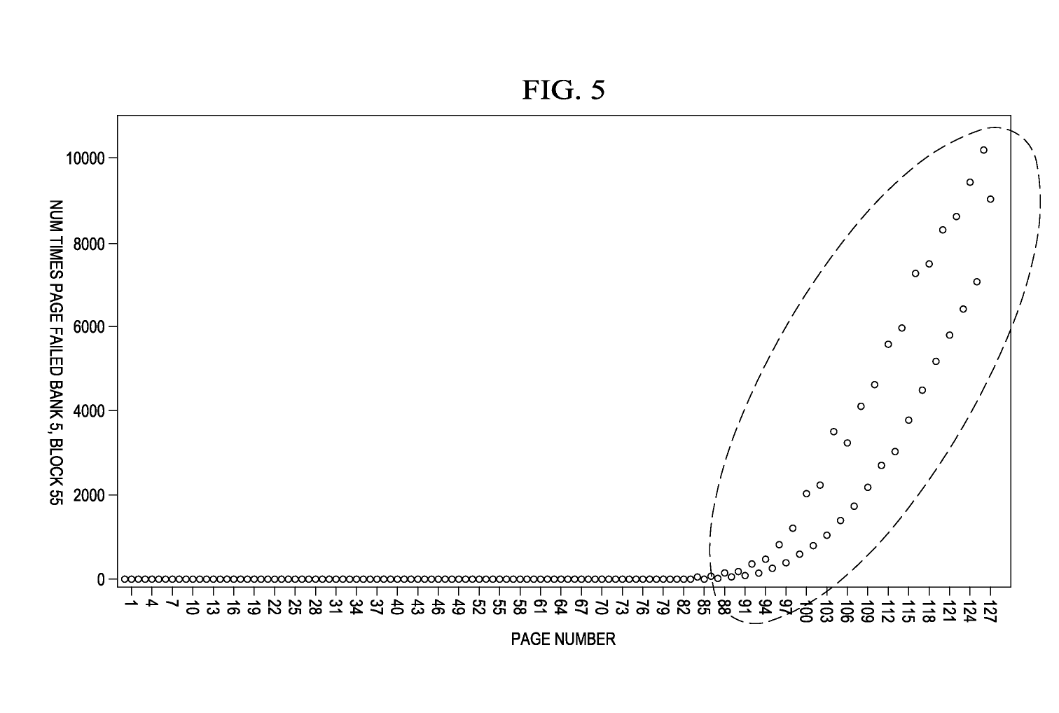

FIG. 5 illustrates a plot of a frequency of page failures for various pages in a block of a MLC flash memory device. The vertical axis in the plot illustrates the number of times the page failed while the horizontal axis represents the page number of the page. It should be appreciated that in an MLC flash memory device, LSB pages and MSB pages are configured physically next to one another in the MLC flash memory device. Thus, an LSB page corresponding to an MSB page is adjacent to the MSB page. This gives rise to the two different curves of the plot exhibited at approximately page number 85. The lower curve on the plot represents the LSB pages whereas the MSB pages are represented by the upper curve of the plotted points. In the depicted example, the block of the MLC flash memory device comprises 64 LSB pages and 64 MSB pages

In the plot shown in FIG. 5, lower numbered pages are farther away from the select gate at source end signal (SGS) connection of the MLC flash memory device. It can be seen from FIG. 5 that the pages that are physically positioned near SGS, e.g., starting at approximately page 85, begin to have larger numbers of failures. This can be explained by the phenomenon known as hot-carrier injection noise. That is, during a program (write) operation, a sufficient voltage difference appears between word lines that are closer to the SGS line. A high transverse electric field is generated which results in creating electron-hole pairs. These pairs end up getting injected into the cells that are closer to the SGS line, resulting in a change in threshold voltage of the cell. This leads to errors in those cells.

In addition to this observation, it can be seen from FIG. 5 that MSB pages have higher numbers of failures than LSB pages, as represented by the two different curves in plotted points. From these observations one can conclude that physical location of a page within a block can affect the failure rates of the page and also that MSB pages fail more often than LSB pages.

Thus, to summarize the observations depicted in FIGS. 3-5, it has been discovered that MSB pages are slower than LSB pages. It has further been discovered that MSB pages have a higher bit error rate (BER) than LSB pages and are more prone to failure. Moreover, it has been determined that physical location of a page affects the bit error rate of the page. The illustrative embodiments exploit the bit error rate and latency differences between pages within a block, as well as the physical location of pages within a block, to achieve a higher performance and longer lifespan for MLC flash memory devices.

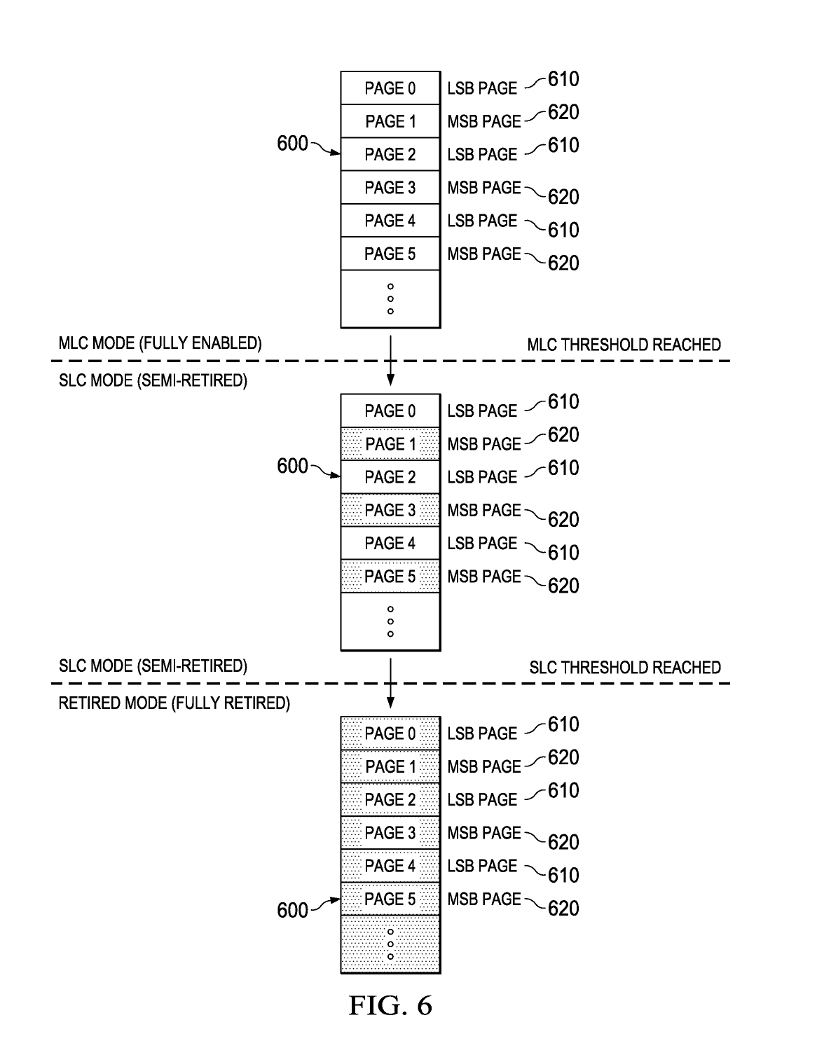

FIG. 6 illustrates one illustrative embodiment for exploiting the difference in bit error rates of least significant and most significant bit pages of a block of a multi-level cell (MLC) flash memory. The mechanisms of this illustrative embodiment utilize different modes of operation of the MLC flash memory block 600 as well as a MLC threshold for determining when to switch from one mode of operation to another. The MLC threshold may be determined according to empirical observation of MLC flash memory devices of the same type and configuration as the MLC flash memory in which block 600 is present, for example. This MLC threshold may be loaded into the MLC flash memory controller as a configuration parameter and may be utilized by the logic of the MLC flash memory controller to control the operational modes of the blocks of the MLC flash memory device.

Various metrics, and/or combinations of metrics, may be utilized as a basis for establishing the MLC threshold depending upon the particular desired implementation. Each of the possible metrics, or combinations of metrics, are related to the bit error rates (BERs) of the pages of a MLC flash memory block 600 such that one can define a relationship between the metric(s) and the BERs and determine that, at a particular threshold value, the BERs of the pages of the MLC flash memory block 600 are likely to increase or be at an undesirable level. For example, with reference again to FIG. 3, one can determine that at approximately 10,000 erase/program/read cycles, the BERs of pages of the MLC flash memory block 600 start to increase and thus, a MLC threshold may be set to 10,000 erase/program/read cycles to be conservative. Alternatively, another implementation may determine that the MLC threshold should be set to 20,000 cycles since a less conservative approach is desirable. It should be appreciated that other metrics, or combinations of metrics, than the erase/program/read cycles could likewise be utilized without departing from the spirit and scope of the illustrative embodiments. The only requirement is that the metrics, or combination of metrics, should be of the type that corresponding metrics for blocks of the MLC flash memory may be monitored and collected by the MLC flash memory controller to determine when to transition from one mode of operation to another.

Regardless of the particular metric selected for the implementation, or the particular threshold value selected to be the MLC threshold, the MLC threshold is loaded into the MLC flash memory controller or otherwise used to configure the MLC flash memory controller to implement the MLC threshold when controlling the operational modes of the MLC flash memory device. The MLC flash memory controller monitors, for each MLC flash memory block 600, the number of occurrences of the metric(s) and compares them to the MLC threshold to determine when to transition the operational mode of the MLC flash memory device for that block. Thus, for example, the MLC flash memory controller may monitor the number of erase/program/read cycles for the MLC flash memory block 600, such as by incrementing a counter for each occurrence of such erase/program/read cycle that occurs, and then compare the value of the counter to the configured MLC threshold. In response to the counter value equaling or exceeding the MLC threshold, the MLC flash memory controller transitions the operation of the MLC flash memory device with regard to that particular MLC flash memory block 600 to a new operational mode, e.g., from a MLC mode of operation to a single-level cell (SLC) mode of operation as described hereafter. For example, if the MLC threshold is set to 10,000 erase/program/read cycles, and a counter of erase/program/read cycles for the MLC flash memory block 600 equals 10,000, then a mode transition is triggered in the MLC flash memory controller for block 600.

In one illustrative embodiment, the transition of operational mode triggered in the MLC flash memory controller comprises a transition from a first mode of operation, i.e. a MLC mode of operation, in which all of the pages of the MLC flash memory block 600 are utilized, to another second mode of operation in which a reduced set of pages of the MLC flash memory block 600 are utilized. In a MLC flash memory implementation where each cell of the MLC flash memory device can store 2 bits of information, the second mode of operation causes the most significant bit (MSB) pages of the MLC flash memory block 600 to be semi-retired and no longer utilized for read/write operations. Thus, only the LSB pages of the MLC flash memory block 600 are utilized for read/write operations when the MLC flash memory controller operates in this second mode of operation with regard to the MLC flash memory block 600.

This second mode of operation will be referred to herein as the single-level cell (SLC) mode of operation in which the cell, while storing a 2 bits of information, only has one bit actually utilized. For example, normally, during MLC mode of operation, each cell can store 2 bits of information (00, 01, 10, or 11). In these examples, assume that the left bit is the most significant bit (MSB) and the right bit is the least significant bit (LSB). When the mode of operation is transitioned to an SLC mode of operation, while each cell can still store 2 bits of information, only one of these bits is utilized and the other bit is not programmed (written to). Thus, in this SLC mode of operation, the cell can store one of the values x0 or x1 (where “x” refers to a “don't care” value). Thus, in essence, during the SLC mode of operation the cell essentially only stores either a 0 or a 1 value, i.e. just one bit.

In this SLC mode of operation, the MLC flash memory block 600 is essentially semi-retired. That is, a portion of the MLC flash memory block 600 is still utilized for reads/writes while other portions of the MLC flash memory block 600 are not and thus, the block 600 is semi-retired. Another threshold, based on the same or different metric(s), may be loaded in the MLC flash memory controller, or otherwise used to configure the MLC flash memory controller, to fully retire the MLC flash memory block 600. For example, a retirement threshold of 20,000 erase/program/read cycles may be specified and, in a similar manner as described above with regard to the MLC threshold, may be used to compare to a metric counter, or a combination of metrics, to determine if the condition of the retirement threshold is met or exceeded. If the retirement threshold is met or exceeded, then the MLC flash memory block 600 is fully retired and no longer used in the MLC flash memory device for reads/writes. Under such a condition, the MLC flash memory block 600 is added to a bad block list (retired list) data structure in the MLC flash memory controller which thereby informs the MLC flash memory controller to no longer utilize that block 600 and instead redirect reads/writes to another block of the MLC flash memory device.

Thus, with reference again to FIG. 6, in the MLC mode of operation, the MLC flash memory block 600 operates normally with reads/writes being sent to both least significant bit (LSB) pages 610 and most significant bit (MSB) pages 620 of the block 600. In response to the MLC threshold being met or exceeded, the MLC flash memory block 600 becomes semi-retired with only the LSB pages 610 being used for read/write operations while MSB pages 620 are no longer utilized for read/write operations. This is shown in FIG. 6 with the MSB pages 620 being shaded to represent that they are no longer utilized for write operations. It should be appreciated that this only affects the memory blocks for which the MLC threshold has been met or exceeded. Thus, the MLC flash memory device may have some blocks that are operating in a full MLC mode of operation while other blocks are operating in an SLC mode of operation.

In the SLC mode of operation, or semi-retired mode of operation, the MLC flash memory controller continues to monitor the selected operational metrics of the MLC flash memory block, such as by utilizing the counters mentioned above. The MLC flash memory controller compares the metric(s) to a retirement threshold to determine if the criteria or conditions of the retirement threshold are met or exceeded. If the retirement threshold criteria or conditions are met, then the MLC flash memory block 600 is fully retired by adding an identifier of the MLC flash memory block 600 to a bad block list (or retired list) data structure in, or associated with, the MLC flash memory controller. This is shown in FIG. 6 with all of the pages, both LSB and MSB, 610 and 620 being shaded indicating that they are no longer utilized for write operations.

The transition of the operational mode of the MLC flash memory from a MLC mode to a SLC mode takes advantage of the differences in bit error rates (BERs) previously described above. That is, as observed above, the BERs of MSB pages begin to significantly rise above the MLC threshold, relative to LSB pages. Thus, by transitioning to an SLC mode of operation in which the MSB pages are no longer utilized for read/write operations when the MLC threshold is met or exceeded, the additional errors encountered by the MSB pages above the MLC threshold are avoided. The tradeoff for this is a loss in density, which amounts to an increased cost per bit, e.g., by just using the LSB pages, the density is reduced to half of the overall density of the block. For example, if one had a 10 GB MLC flash memory device, if only the LSB pages are used in all blocks of the flash memory device, the density and storage capacity of the flash memory device becomes half, i.e. 5 GB.

In order to keep track of which MLC flash memory blocks are in a MLC mode of operation or a SLC mode of operation, metadata may be stored in, or associated with, the MLC flash memory controller. For example, this metadata may comprise 1 bit per block in a metadata data structure that can be set to one of two states. In one state, the bit indicates that the corresponding block is in a MLC mode of operation, whereas in the other state, the bit indicates that the corresponding block is in an SLC mode of operation. This metadata data structure may be consulted by the MLC flash memory controller when routing write operations to pages of the MLC flash memory block so as to utilize all or only a subset of the pages of the block, e.g., only the LSB pages of the block.

It should be appreciated that in other types of MLC flash memory architectures, such as a triple level cell (TLC) flash memory architecture, additional modes of operation, thresholds, and metadata bits may be used to allow transitioning between more than two modes of operation and to keep track of more than two modes of operation in the metadata. For example, with regard to a TLC flash memory architecture, three modes of operation may be established including the MLC mode of operation (in this case referred to as a TLC mode of operation), a SLC mode of operation, and an intermediate mode of operation. In the intermediate mode of operation, the LSB and CSB pages may be utilized while the MSB pages are not, for write operations. In the SLC mode of operation, he LSB pages may be utilized for write operations. Three thresholds may be established for transitioning from the MLC mode of operation to the intermediate mode of operation, and then from the intermediate mode of operation to the LSB mode of operation. The thresholds again may be established based on empirical observation of the BERs of the TLC and their trends to determine when it is appropriate to transition from one mode to another. To keep track of these three possible modes of operation the metadata data structure may comprise 2 or more bits of metadata for each block so as to inform the MLC flash memory controller of the current operational mode of each block of the MLC flash memory.

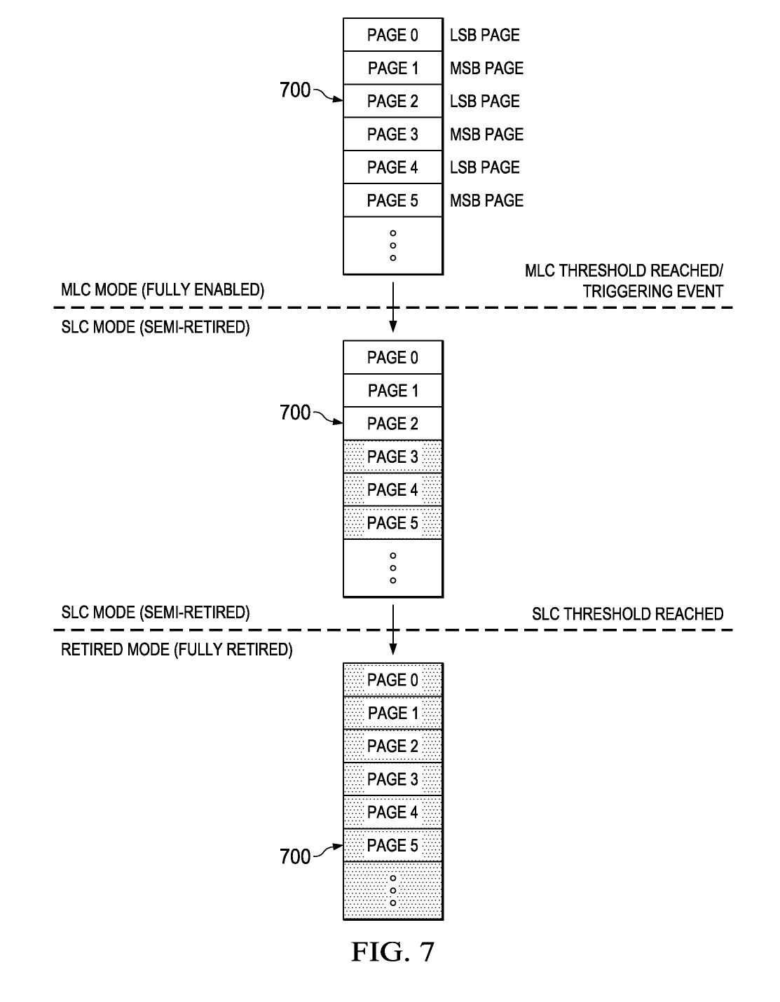

In another illustrative embodiment, when a threshold is reached, such as the MLC retirement threshold or another set threshold, or when a triggering event is detected, e.g., a number of errors that have been captured reaches a trigger value, the MLC flash memory controller switches from a healthy block mode of operation to a semi-retired block mode of operation in which pages of the MLC device are utilized according to their physical location within the block. FIG. 7 illustrates an example embodiment in which the page utilization for a MLC flash memory block is dependent upon physical location of the pages. In the example depicted in FIG. 7, the upper half 710 of the MLC flash memory block 700 is physically located relatively closer to a SGS connection of the circuit than the lower half 720 of the MLC flash memory block 700.

When the MLC retirement threshold, other threshold, or triggering event is met, the MLC flash memory block 700 is set to a semi-retired mode of operation in which only a subset of the pages of the block 700 are used for read/write operations based on their physical location relative to SGS. For example, a subset of pages of the block 700 relatively closest to SGS are selected for continued use with write operations in the semi-retired mode of operation. In one illustrative embodiment, the upper half 710 of the MLC flash memory block 700 are selected for continued utilization whereas the lower half 720 of the block 700 are set to a retired state and are no longer utilized for write operations. The MLC flash memory controller may set metadata bit(s) for the block to indicate that the block 700 is in a semi-retired state and thus, the MLC flash memory controller is to use a semi-retired mode of operation when writing to the MLC flash memory block 700.

As with the illustrative embodiment described above with regard to FIG. 6, the MLC flash memory controller may continue to monitor the metrics and/or triggering events to determine if and when to fully retire the MLC flash memory block 700. For example, if the number of erase/program/read cycles reaches a predetermined threshold value, then the block 700 may be transitioned to a fully retired stated in which all of the pages are retired and no longer utilized for write operations, such as by adding an identifier of the block 700 to the bad block list (retired list) data structure.

It should be appreciated that the illustrative embodiment that selects portions of the MLC flash memory block based on physical location may be combined with other illustrative embodiments described herein. For example, with regard to the illustrative embodiment shown in FIG. 6 and described above, in a combined illustrative embodiment, the MLC flash memory controller may implement the mechanisms of the FIG. 6 illustrative embodiment, such that the mode of operation is transitioned from a MLC mode of operation to an SLC mode of operation in response to metric, or combination of metrics, meeting or exceeding the MLC threshold. In addition, the MCL flash memory controller may also select a portion of the MLC flash memory block based on physical location. In such an embodiment, the upper half of the MLC flash memory block may be selected for continued use and only the LSB pages in this upper half may be utilized in accordance with the illustrative embodiment described above with reference to FIG. 6. In other illustrative embodiments, the selection based on physical location of the pages may be performed at a different threshold than the MLC threshold or in response to an event, such as a number of errors encountered over the lifetime of the MLC flash memory device reaching a particular value, a certain number of errors occurring within a particular period of time, or the like. In such a case, the triggering of the transition from the MLC mode to the SLC mode of operation may occur at a different time than the selection of a portion of the block based on physical location.

Thus, in addition to, or alternative to, the increase in lifetime of the MLC flash memory device obtained by transitioning from one mode to another to semi-retire the MLC flash memory blocks as described above, the illustrative embodiments may further leverage the physical location of pages of the MLC flash memory blocks to improve the longevity of the MLC flash memory device. That is, as observed above, the pages that are physically located relatively further away from the SGS connection tend to experience larger bit error rates than those that are relatively closer to the SGS connection. Hence, the illustrative embodiments may further select portions of the MLC flash memory blocks based on their relative physical location to the SGS connection so as to discontinue use of the pages of the block further away from SGS once a threshold is met or a triggering event occurs.

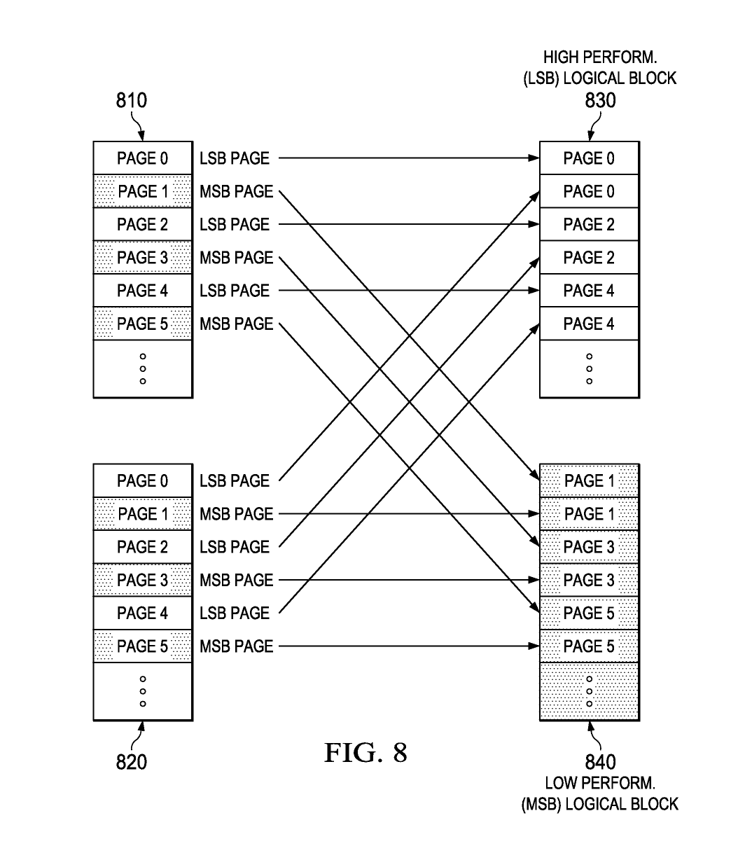

FIG. 8 illustrates another illustrative embodiment in which pages of a MLC flash memory block are combined to generate high performance blocks for high performance applications. That is, in addition to the above illustrative embodiments, in some additional illustrative embodiments, mechanisms are provided to exploit the difference in latencies between LSB pages and MSB pages of a block. In such illustrative embodiments, if the MLC flash memory controller utilizes page based mapping, high performance applications read/write from LSB pages that are determined to have less latency, whereas low performance applications read/write from MSB pages. If the MLC device controller utilizes block based mapping, LSB pages may be combined from two or more blocks to create a high performance block for use by high performance applications while MSB pages of these two or more blocks may be combined to create a low performance block for low performance applications.

As shown in FIG. 8, two MLC flash memory blocks are provided 810 and 820, each having corresponding LSB and MSB pages 812, 814 and 822, 824. In the depicted example, when generating a high performance logical block 830 and a low performance logical block 840 from the two physical blocks 810 and 820, the MLC flash memory controller may logically combine the LSB pages of the two physical blocks 810 and 820 to generate a LSB logical block 830 and logically combine the MSB pages of the two physical blocks 810 and 820 to generate a MSB logical block 840. Thus, the LSB logical block 830, in the depicted example, comprises the even numbered pages (which correspond to the LSB pages) from each of the physical blocks 810 and 820 and the MSB logical block 840 comprises the odd numbered pages (which correspond to the MSB pages) from each of the physical blocks 810 and 820. Metadata, such as an additional bit per block, may be set to indicate whether the block has been used to create logical high and low performance blocks. This metadata may be in addition to other metadata already existing in the system for identifying where to read from and write to in the MLC flash memory device. For page-mapped addressing, the single bit per block may be used to identify whether the block has been semi-retired or not. For block-mapped addressing, additional metadata may be provided in addition to this bit per block.

Reads and writes from higher performance applications, as may be identified by the application itself, the operating system, or another layer in the system stack which then notifies the MLC flash memory controller that the application is a high performance application, are directed by the MLC flash memory controller to the logical high performance block 830 whereas reads/writes from other lower performance applications may be directed to the low performance block 840. The creation of these high and low performance logical blocks 830 and 840 may be done during normal MLC operation of the MLC flash memory device or in response to a threshold being met or a triggering event. That is, the creation of such high and low performance blocks may be a default operation of the MLC flash memory device and operate even when no threshold or triggering event has occurred to cause one or more of the other illustrative embodiments described herein to be implemented. In other illustrative embodiments, however, the creation of the high and low performance logical blocks 830 and 840 may be performed in response to a threshold or triggering event being met/encountered in the manner previously described above with regard to the other illustrative embodiments.

For example, a threshold, event, or the like, may be established for determining when to create a high performance and low performance block in the manner described above. This threshold, event, or the like, is preferably configured so as to occur prior to any occurrence of the meeting or exceeding of the MLC threshold. Thus, prior to transitioning from the MLC mode of operation to the SLC mode of operation, this threshold/event associated with the creation of the low and high performance blocks may be encountered and the low and high performance blocks may be created using the mechanisms of the illustrative embodiments. Thereafter, when the MLC threshold is met or exceeded, the MSB based low performance block (comprising the MSB pages) may be semi-retired while the high performance block (comprising the LSB pages) may continue to be utilized. The same can be done with illustrative embodiments in which physical location of pages is used as a basis to select a portion of the block to be utilized after a semi-retirement threshold is met or exceeded, or triggering event (e.g., a number of errors encountered meets or exceeds a predetermined value). In such a case, in some illustrative embodiments, only the LSB pages of the selected portion of the block and the MSB pages of the selected portion of the block are combined with LSB and MSB pages of similarly selected portions of other semi-retired blocks.

In some illustrative embodiments, mechanisms are provided to improve garbage collection on MLC devices. In such illustrative embodiments, valid pages of full blocks of memory identified during garbage collection are moved to LSB pages of semi-retired blocks. In this way, the full block from which the valid pages are moved may be garbage collected and reused for storage of data. The garbage collection itself is done in a standard manner but is directed to the MSB pages. The writes to the LSB pages are done in a faster manner than writes to MSB pages and thus, the writes to move the valid pages of the full blocks to the LSB pages is done in a quicker and more efficient manner than if the writes were done to both LSB and MSB pages.

In still further illustrative embodiments, power management mechanisms may be employed to switch the MLC flash memory controller from a full MLC mode of operation to a semi-retired mode of operation or SLC mode of operation where only the LSB pages of blocks of memory are utilized. That is, if the system needs to enter a power saving mode of operation, as may be determined by the operating system, other upper layer in the system stack, or the MLC flash memory controller itself which may monitor consumed power and determine, using one or more algorithms that there is a need to transition to a power saving mode of operation, this information may be relayed to the MLC flash memory controller which may then temporarily set the metadata for the blocks of the MLC flash memory device to a semi-retired state. This may be considered a triggering condition, for example, for one or more of the illustrative embodiments described above. As a result, at least temporarily, reads/writes to blocks of memory in the MLC flash memory device occur only with respect to the LSB pages, which are determined to require less power to access than the MSB pages. If the system exits the power saving mode of operation, this information may be relayed to the MLC flash memory controller which may then re-set the metadata for the blocks of the MLC device to be in full MLC mode of operation and thereby return the MLC flash memory device to full MLC operational status.

Thus, the mechanisms of the illustrative embodiments provide for improved wear on MLC flash memory devices by extending the lifetime of the MLC flash memory device to permit a semi-retired state of operation. That is, instead of retiring entire blocks when an operational characteristic, e.g., bit error rate, number of errors encountered, or the like, meets or exceeds a threshold, the mechanisms of the illustrative embodiments allow for various implementations of a semi-retired state that allows the block to continue to function in a diminished capacity, e.g., MSB pages are not utilized, a portion of the block is not utilized, or pages are logically combined to provide high/low performance logical blocks. This effectively extends the lifetime of the MLC flash memory device while still providing sufficient performance due to the exploitation of the latency, power consumption, and bit error rate differences between LSB and MSB pages of MLC flash memory blocks.

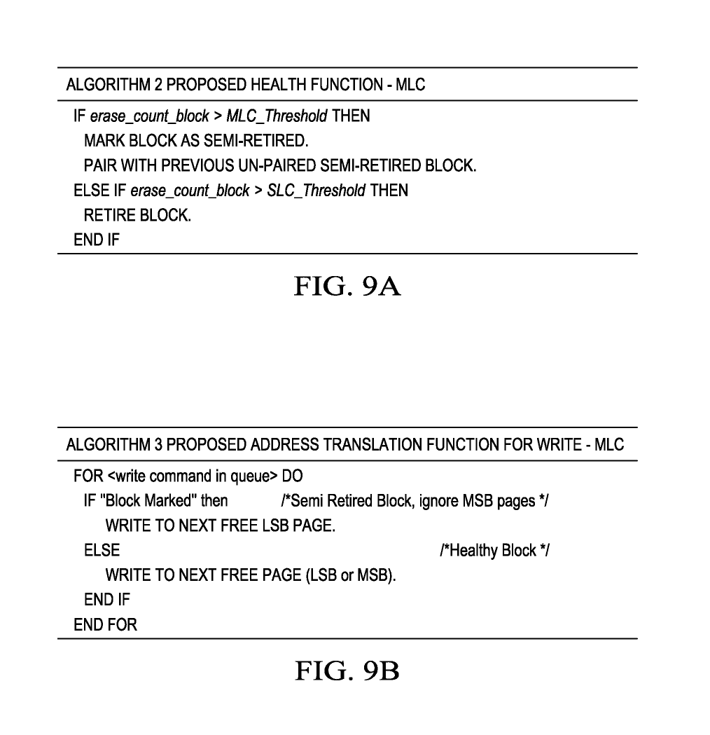

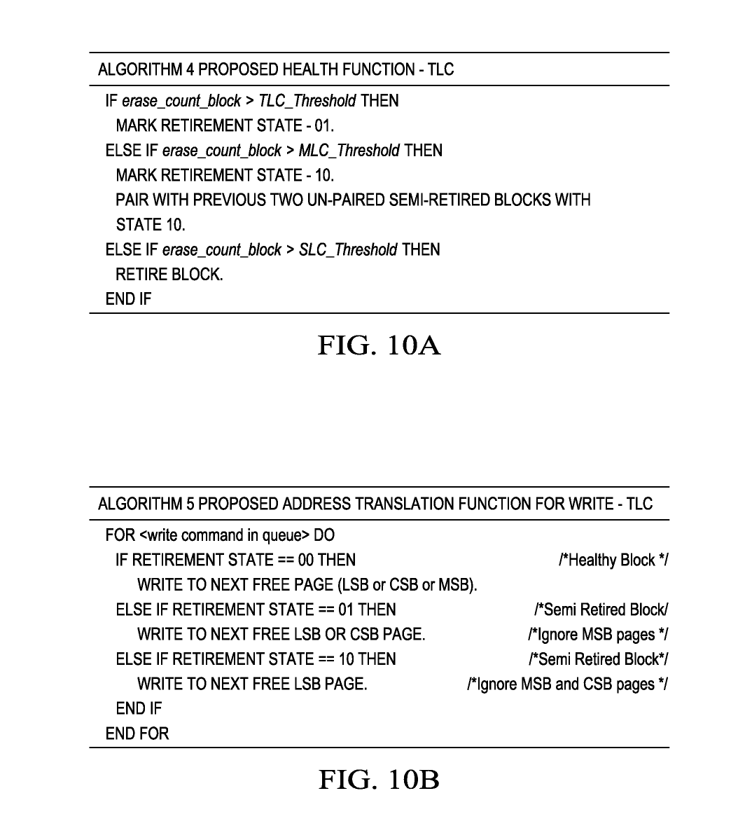

As noted above, the illustrative embodiments are not limited to use with only MLC flash memory devices in which the cells store 2 bits of information. To the contrary, the illustrative embodiments may be extended for use with TLC flash memory devices, and flash memory devices in which the cells store more than three bits of information, as may be later developed. To illustrate this, FIGS. 9A and 9B illustrate example pseudo-code for implementing a health function and address translation for writes for an MLC flash memory device while FIGS. 10A and 10B illustrate example pseudo-code for implementing a similar health function and address translation for writes for a TLC flash memory device. These are only examples of pseudo-code and are not intended to be limiting on the present illustrative embodiments. These are only used to illustrate the applicability of the mechanisms of the illustrative embodiments to different types of multi-level cell flash memory devices.

Before discussing FIGS. 9A-9B and 10A-10B, it should be noted that erase_count block in these figures refers to an example counter that counts the number of erasure operations that have been applied to the flash memory block. This may correspond to an example counter maintained by, or associated with, the flash memory controller as discussed above. Similarly, the MLC threshold or TLC_threshold are the threshold values for determining when to transition the flash memory block to a semi-retired state. SLC_Threshold refers to a threshold value for transitioning the flash memory block from a semi-retired state to a fully retired state. In a baseline operation of a flash memory device, when the erase_count block is greater than the MLC threshold or TLC_threshold, then entire flash memory block is retired. However, as shown in FIGS. 9A-9B and 10A-10B, such is not the case with the illustrative embodiments which provide a semi-retired state for use with flash memory blocks.

As shown in FIG. 9A, the health function of the MLC flash memory device comprises determining if the erase_count_block counter value exceeds the MLC_threshold. If the MLC_threshold is exceeded, then the flash memory block is marked as semi-retired, e.g., the metadata bit associated with the block is set to a value indicative of a semi-retired state, and the block is paired with a previous unpaired semi-retired block, e.g., the LSB and MSB pages are logically combined to generate a high performance and low performance logical block. If the erase_count_block exceeds the SLC_threshold, the block is marked as retired and added to the bad block list (retired list) as described previously.

As shown in FIG. 9B, the address translation for the MLC flash memory determines, for the write commands in the queue, if the block is marked as semi-retired. If so, writes are sent to the next free LSB page. Otherwise, if the block is not marked as semi-retired, the write is sent to the next free page, whether that be an LSB page or an MSB page.

Similar operations are shown in FIGS. 10A and 10B with regard to a TLC flash memory device. As shown in FIG. 10A, a similar operation is provided except that there are three thresholds, i.e. the TLC_threshold, MLC_threshold, and SLC_threshold, that are provided and two bits are used to mark the state of the block. If the erase_count_block is greater than the TLC_threshold, then the retirement state for the block is set to 01 indicating an MLC state, or mode of operation, for the block. If the erase_count_block is greater than the MLC threshold, then the retirement state is set to 10 indicating an SLC state, or mode of operation, for the block. In addition the semi-retired block is paired with an unpaired semi-retired block with state 10. If the erase_count_block exceeds the SLC_threshold, then the block is retired.

With regard to FIG. 10B, for the write commands in the queue, it is determined if the retirement state of the block is 00 in which case the write is sent to the next free page in the block, whether that be an LSB, CSB, or MSB page. If the retirement state is 01, i.e. semi-retired state in which MSB pages only are ignored, then the write is sent to the next free LSB or CSB page. If the retirement state is 10, i.e. a semi-retired state in which both CSB and MSB pages are ignored, then the write is sent to the next free LSB page. Thus, it is clear that the mechanisms of the illustrative embodiments may be extended to TLC flash memory devices and those of ordinary skill in the art will recognize additional applications to flash memory devices of larger numbers of bits per cell or larger numbers of states.

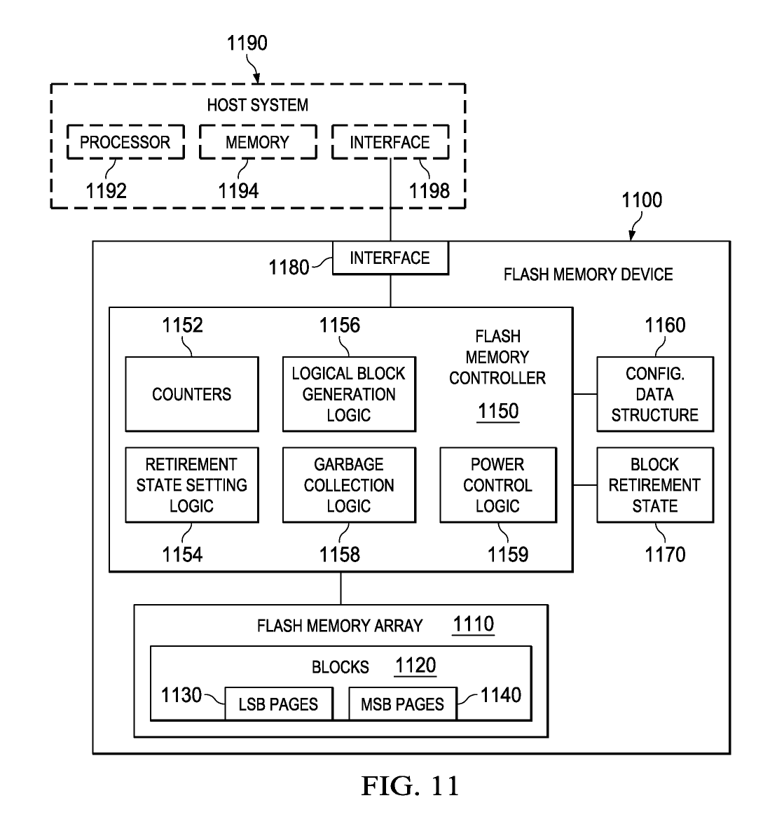

FIG. 11 is an example block diagram of a flash memory device implementing the flash memory controller and corresponding logic in accordance with one or more of the illustrative embodiments previously described above. It should be appreciated that the elements shown in FIG. 11 may be implemented in special dedicated hardware, firmware, software executing on hardware, or any combination of specialized hardware, firmware, or software executing on hardware. In one illustrative embodiment, the flash memory controller is implemented as hardware and firmware with some operations possibly being implemented in software loaded into the flash memory controller and executed by the flash memory controller to thereby execute the operations. For purposes of the description of FIG. 11, it will be assumed that the flash memory device is a MLC flash memory device in which cells may store 2 bits of information, but as noted above the illustrative embodiments may be utilized with any flash memory configuration comprising cells storing three or more bits of information.

As shown in FIG. 11, the flash memory device 1100 comprises a flash memory array 1110 having blocks of flash memory cells 1120. The blocks 1120 comprise pages 1130 and 1140. A first set of the pages 1130 are LSB pages storing the least significant bits of the word lines in the flash memory array 1110. A second set of the pages 1140 are MSB pages storing the most significant bits of the word lines in the flash memory array 1110.

Data may be written to, and read from, the flash memory array 1110 via the interface 1180, which may contain read/write buffers and other circuitry for facilitating communication between the flash memory device 1100 and a host system or other external data processing device 1190, having at least one processor 1192, a memory 1194, and an interface 1198 for communicating with the flash memory device 1100. The reading/writing of the data from/to the flash memory array 1110 by the host system 1190 is controlled, on the flash memory side of the communication, by the flash memory controller 1150 of the flash memory device 1100.

As noted above, the flash memory device 1100 further comprises a flash memory controller 1150. This flash memory controller 1150 is associated with a configuration data structure 1160 and block retirement state metadata data structure 1170. The data structures 1160 and 1170 may be stored in a memory associated with the flash memory controller 1150, for example, and may be accessible by the flash memory controller 1150. The configuration data structure 1160 is accessible by the flash memory controller 1150 to obtain configuration information including set threshold values, trigger event information, semi-retirement states enabled for the flash memory controller 1150, power control settings, and other configuration information influencing the manner by which the flash memory controller 1150 controls the operation of the flash memory device 1100 and especially with regard to the reading/writing of data from/to the blocks 1120, and pages 1130 and 1140 within blocks, of the flash memory array 1110.

The block retirement state metadata data structure 1170 stores the current state of the various blocks 1120 of the flash memory array 1110 with regard to whether the block is in a full MLC mode of operation, is in one of one or more semi-retired states of operation, or is fully retired, i.e. on a bad block list or retired list. In addition, the block retirement state metadata data structure 1170 may further store state data indicative of which blocks are logically combined with which other blocks such that high and low performance logical blocks are generated from the combinations, as previously described above.

The flash memory controller 1150 comprises one or more operational characteristic counters 1152, retirement state setting logic 1154, logical block generation logic 1156, garbage collection logic 1158, and power control logic 1159. The one or more operational characteristic counters 1152 comprises at least one counter for each block 1120 in the flash memory array 1110 and counts the number of occurrences of a particular operational characteristic for the corresponding block 1120, i.e. the counters 1152 provide indicators of metrics of operational characteristics of the corresponding block 1120. For example, there may be a counter for each block 1120 that counts the number of erasure operations that have occurred to that block 1120 and this count may be used to determine when to transition to a semi-retired state as described previously. Of course multiple counters for each block may be maintained and a combination of these counters and corresponding thresholds, or a function of these various counter values, may be used as a basis for determining when to transition from one operational mode or state to another.

The retirement state setting logic 1154 comprises logic for comparing operational characteristic metrics, or combinations of metrics, such as those provided by the counters 1152, to one or more thresholds or triggering event criteria specified in the configuration data structure 1160 which is used to configure the flash memory controller 1150. Based on results of the comparisons, the retirement state setting logic 1154 sets the operational mode of the blocks 1120 of the flash memory array 1110, such as by setting appropriate bits in the block retirement state metadata data structure 1170 for the block 1120. These operational modes may be a fully enabled mode, e.g., a MLC mode of operation for a MLC flash memory device, a semi-retired mode of operation (which may be one of a plurality of different semi-retired modes of operation in the case of a TLC flash memory device or a flash memory device in which cells may store more than three bits of information, or a fully retired mode of operation.

The logical block generation logic 1156 comprises logic for logically combining pages of pairs of blocks to generate high performance logical blocks and low performance logical blocks. As noted above, this may be done as part of a default operation of the flash memory device 1100, i.e. when the blocks are in a fully enabled mode of operation, or may be done in response to a transition to a semi-retired state or mode of operation. The logical block generation logic 1156 may set metadata bits for specifying which blocks are logically combined in this manner.

The garbage collection logic 1158 comprises logic for performing garbage collection utilizing the LSB and MSB pages of semi-retired blocks 1120 in the flash memory device. That is, the garbage collection logic 1158, in response to a request to perform garbage collect, such as due to a periodic garbage collection operation scheduled by the flash memory controller 1110, an explicit request to perform garbage collection from an application or user input, or the like, moves valid pages of full blocks of memory, i.e. blocks of memory operating in a fully enabled mode of operation and not a semi-retired or retired mode of operation, identified during garbage collection to LSB pages of semi-retired blocks. In this way, the full block from which the valid pages are moved may be garbage collected and reused for storage of data.

The power control logic 1159 comprises logic for determining whether the flash memory device 1100 is placed in a power savings mode of operation by the host system, such as by receiving a request to enter the power savings mode of operation via the interface from the host system. In response to the request to place the flash memory device 1100 in a power savings mode of operation, the power control logic 1159 sets the operational mode bits in the retirement state metadata data structure 1170 to specify that the blocks 1120 of the flash memory array 1110 are in a semi-retired mode of operation or state. In this way, only the LSB pages are utilized in each of the blocks 1120 of the flash memory array 1110, which require less power to write to than MSB pages. If the power control logic 1159 detects a request to discontinue the power savings mode of operation, the power control logic 1159 re-sets the metadata for the blocks 1120 in the retirement state metadata data structure 1170 to again indicate fully operational mode of the blocks 1120 of the flash memory array 1110.

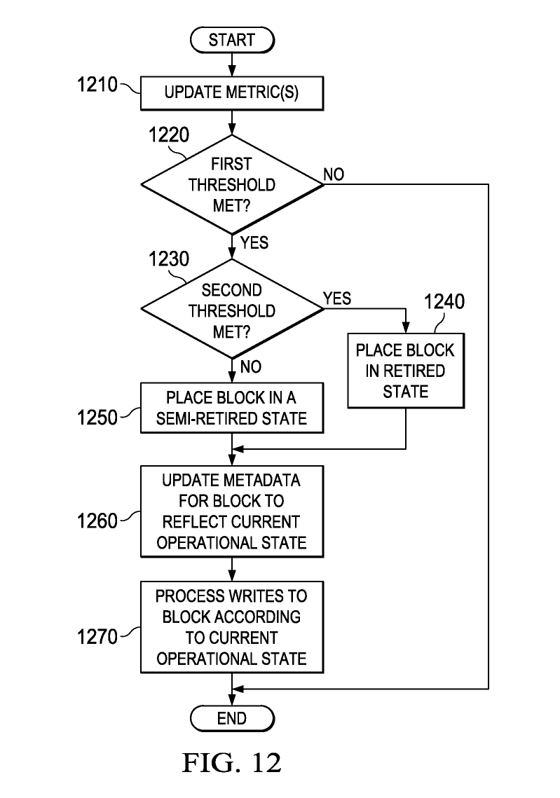

FIG. 12 is a flowchart outlining an example operation for performing multi-stage retirement of a block of flash memory in accordance with one illustrative embodiment. For purposes of the description of FIG. 12, it will be assumed that the flash memory device is a MLC flash memory device with cells storing 2 bits of information. It is assumed that the flash memory is already configured with appropriate thresholds, enabled retirement modes of operation, counters have been initialized, and appropriate metadata has been set to reflect a fully operational flash memory device and corresponding block. The operation outlined in FIG. 12 is for a single block of the flash memory device and may be repeated for each block of memory in the flash memory device.

As shown in FIG. 12, the operation starts with at least one operational metric of the flash memory block being updated (step 1210). The at least one operational metric may be, for example, a number of erasures of the block of memory due to an erasure operation having been performed, a number of corrected errors being updated due to an error correction operation being performed, or the like. The metric update may be detected, for example, by a change in the value of a counter.

In response to the operational metric of the flash memory block having been updated, the flash memory controller checks a first threshold to determine if the first threshold has been met or exceeded by the updated metric, or a combination of operational characteristic metrics associated with the block (step 1220). This first threshold may be, for example, a MLC threshold for determining when to transition the flash memory device from a fully MLC mode of operation to a SLC mode of operation.

If the first threshold is met or exceeded, then a determination is made as to whether a second threshold has been met or exceeded by the operational metric or combination of operational metrics (step 1230). This second threshold may be, for example, an SLC threshold for determining when to transition the block from a SLC mode of operation to a retired mode of operation (or non-operation). If so (step 1230:YES), the block is transitioned to a retired state and an identifier of the block is added to a bad block list (retired list) or metadata associated with the block is set to indicate the block to be fully retired (step 1240).

If the second threshold has not been met or exceeded (step 1230:NO), then the block is transitioned from a fully enabled mode of operation to a semi-retired mode of operation (step 1250). Again, it should be appreciated that in architectures that facilitate storage of more than 2 bits in each cell of the flash memory array, multiple semi-retired modes of operation may be present, e.g., a first semi-retired mode of operation in which only MSB pages are ignored during writing, and a second semi-retired mode of operation in which both CSB pages and MSB pages are ignored during writing. In such architectures, step 1250 may in fact transition from one semi-retired mode of operation to another semi-retired mode of operation. Essentially, the modes of operation are progressed incrementally towards full retirement of the block.

In the semi-retired mode of operation, one or more of the following conditions apply. First, a sub-set of pages of the block no longer utilized for write operations based on physical location of these pages, e.g., only an upper half of the pages are utilized or a portion that is closest to the SGS connection. Second, only the LSB pages of the block are utilized for write operations (or LSB and CSB pages in first semi-retired mode of operation of a TLC architecture) with the MSB pages being ignored for write operations and write operations are redirected to the next available LSB page. Third, generation of high performance and low performance logical blocks may be initiated for semi-retired blocks so as to provide high performance for high performance applications.

Metadata associated with the block is updated to reflect the current operational mode of the block (step 1260) and write operations to the block are controlled using the current operational mode of the block (step 1270). The operation then terminates. It should be appreciated that while the flowchart is shown as terminating at step 1270, this process may be repeated with each update to an operational metric that may influence the operational mode of the flash memory device. Thus, in some illustrative embodiments, this process may be continual with monitoring for updates to metrics being done on a continual basis by the flash memory controller. In other illustrative embodiments, this process may be performed periodically, such as according to a schedule or in response to the occurrence of a particular event, e.g., an erasure of the block, the correction of an error in the block, or the like.

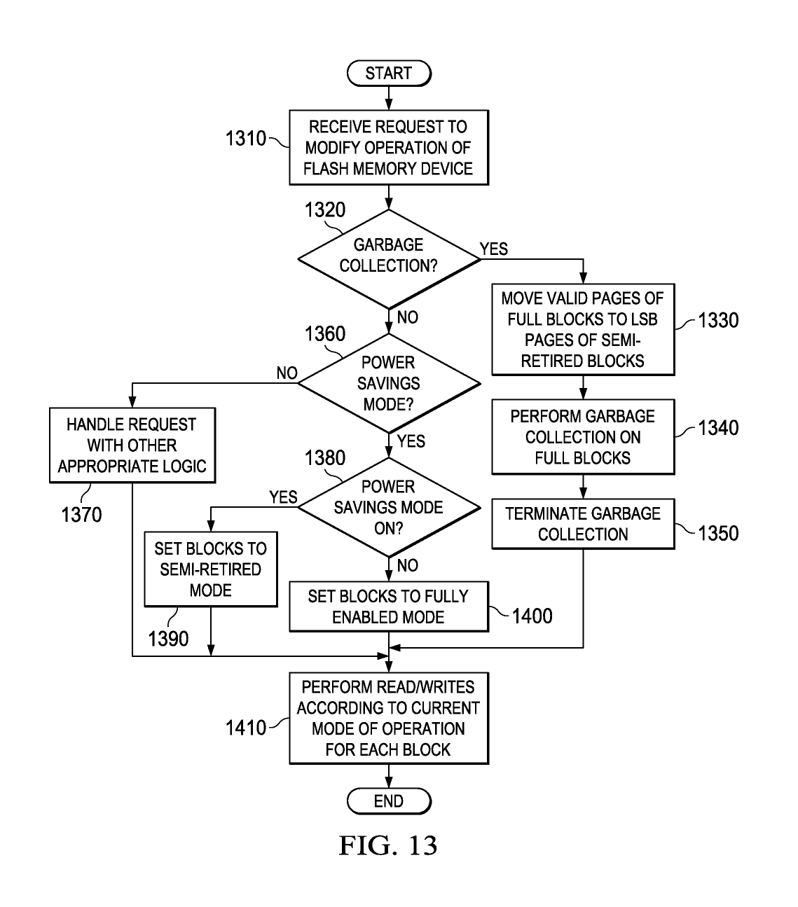

FIG. 13 is a flowchart outlining an example operation for controlling the operation of a flash memory device in response to a garbage collection request or power savings request in accordance with one illustrative embodiment. As with FIG. 12 above, for purposes of the description of FIG. 13, it will be assumed that the flash memory device is a MLC flash memory device with cells storing 2 bits of information. It is again assumed that the flash memory is already configured with appropriate thresholds, enabled retirement modes of operation, counters have been initialized, and appropriate metadata has been set to reflect a fully operational flash memory device and corresponding block. The operation outlined in FIG. 13 is for a single block of the flash memory device and may be repeated for each block of memory in the flash memory device.

As shown in FIG. 13, the operation starts with receiving a request to modify the operation of the flash memory device (step 1310). A determination is made as to whether the request is to perform garbage collection on the flash memory array (step 1320). If so (step 1320:YES), then valid pages of blocks of the flash memory array that are in a fully enabled mode of operation are moved to the LSB pages of semi-retired blocks of the flash memory array (step 1330). The garbage collection is then performed with regard to the fully enabled blocks of the flash memory array to thereby reclaim these blocks for future read/write operations (step 1340). The actual operations performed during garbage collection are old and well known and thus, are not detailed here. Any garbage collection methodology may be utilized without departing from the spirit and scope of the present invention with the importance being on the movement of valid pages to LSB pages of semi-retired blocks in accordance with the illustrative embodiments. The garbage collection operation then terminates (step 1350).

If the request is not for garbage collection, a determination is made as to whether the request is for a power savings mode of operation of the flash memory device (step 1360). If this request is not for a power savings mode of operation, then the request is handled by other logic corresponding to the particular request, which is outside the scope of the present description (step 1370). The operation then terminates.

If the request is for a power savings mode of operation (step 1360:YES), a determination is made as to whether the request is to enter or exit a power savings mode of operation (step 1380). If the request is to enter a power savings mode of operation (step 1380:YES) then the flash memory controller sets all of the blocks of the flash memory array to a semi-retired mode of operation in which only the LSB pages are utilized for writes (step 1390). If the request is to exit the power savings mode of operation (step 1380:NO), then the flash memory controller sets all of the blocks of the flash memory array to a fully enabled mode of operation in which all of the pages of the blocks are utilized (step 1400). Read/writes are then performed in accordance with the current operational mode of the flash memory device and the locations of the data (step 1410). The operation then terminates.

Thus, the illustrative embodiments provide mechanisms for improving the lifetime, and reducing wear, on a flash memory device, and in particular a MLC or TLC flash memory device. The mechanisms of the illustrative embodiments leverage the differences in bit error rates and latency between least significant bit and most significant bit pages of blocks of the flash memory arrays as well as the physical locations of the pages within the blocks. Moreover, the mechanisms may improve garbage collection by moving valid pages of fully enabled blocks to least significant bit pages of semi-retired blocks. Furthermore, the mechanisms of the illustrative embodiments enable the use of a power savings mode of operation in the flash memory device by utilizing only the least significant bit pages of the blocks in the flash memory array.

It should be appreciated that aspects of the illustrative embodiments may take the form of an entirely hardware embodiment, an entirely software embodiment or an embodiment containing both hardware and software elements. In one example embodiment, the mechanisms of flash memory controller of the illustrative embodiments are implemented in software or program code, which includes but is not limited to firmware, resident software, microcode, etc.

The flash memory device mechanisms of the illustrative embodiments may be utilized with, integrated in, or otherwise associated with a data processing system computing system, or the like. A data processing system with which the mechanisms of the illustrative embodiments may be implemented will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art without departing from the scope and spirit of the described embodiments. The embodiment was chosen and described in order to best explain the principles of the invention, the practical application, and to enable others of ordinary skill in the art to understand the invention for various embodiments with various modifications as are suited to the particular use contemplated. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, in multi-layer cell (MLC) flash memory device comprising a MLC flash memory and a controller, for controlling an operation of the MLC flash memory device, the method comprising:
controlling, by the controller, accesses to a block of memory pages in the MLC flash memory to be performed to the full block of memory pages in a MLC mode of operation;
determining, by the controller, whether a MLC retirement threshold has been met or exceeded by an operating characteristic of the block of memory pages;
switching, by the controller, in response to detecting that the operating characteristic of the block of memory pages has met or exceeded the MLC retirement threshold, an operating mode associated with the block of memory pages from the MLC mode of operation to a single-level cell (SLC) mode of operation in which a sub-set of pages of the block of memory pages are utilized for access operations; and
controlling, by the controller, access operations to the block of memory pages in accordance with the SLC mode of operation in response to switching the operating mode of the block of memory pages from the MLC mode of operation to the SLC mode of operation.

2. The method of claim 1, wherein the sub-set of pages of the block of memory pages that are utilized for access operations comprises least significant bit (LSB) pages of the block of memory pages, and wherein most significant bit (MSB) pages of the block of memory pages are not utilized for access operations while the MLC flash memory device is operating in the SLC mode of operation.

3. The method of claim 1, further comprising:
determining, by the controller, whether a SLC retirement threshold has been met by the operating characteristic of the block of memory pages; and
retiring, by the controller, the block of memory pages in response to the SLC retirement threshold being met, wherein the block of memory pages is not utilized for access operations in response to the block of memory pages being retired.

4. The method of claim 1, wherein the sub-set of pages of the block of memory pages that are utilized for access operations while the MLC flash memory device is operating in the SLC mode of operation comprises a sub-set of pages that are furthest from a select gate at source end signal (SGS) connection of the block of memory pages relative to a second sub-set of pages of the block of memory pages.

5. The method of claim 1, wherein controlling accesses to a block of memory pages in the MLC flash memory to be performed to the full block of memory pages in the MLC mode of operation further comprises:
creating, by the controller, a high performance logical block from a first sub-set of pages of blocks of pages in the MLC flash memory;
creating, by the controller, a low performance logical block from a second sub-set of pages of blocks of pages in the MLC flash memory;
directing, by the controller, access operations from a high performance application to the high performance logical block; and
directing, by the controller, access operations from a non-high performance application to the low performance logical block.

6. The method of claim 5, wherein the first sub-set of pages of blocks of pages in the MLC flash memory comprises least significant bit (LSB) pages of the blocks of pages in the MLC flash memory, and wherein the second sub-set of pages of blocks of pages in the MLC flash memory comprises most significant bit (MSB) pages of the blocks of pages in the MLC flash memory.

7. The method of claim 1, further comprising:
determining, by the controller, that a garbage collection operation on blocks of the MLC flash memory device is to be performed;
moving, by the controller, valid pages of blocks of the MLC flash memory device to least significant bit (LSB) pages blocks of the MLC flash memory operating in a SLC mode of operation; and
responsive to completion of the moving of the valid pages, performing, by the controller, garbage collection on the blocks of the MLC flash memory device.

8. The method of claim 1, wherein the operating characteristic of the block of memory pages comprises a number of erasure operations performed on the block of memory pages.

9. The method of claim 1, wherein switching an operating mode associated with the block of memory pages from the MLC mode of operation to a single-level cell (SLC) mode of operation further comprises storing an indicator of a mode of operation of the block of memory pages in a block retirement state data structure storage of the MLC flash memory device, and wherein a separate indicator is stored in the block retirement state data structure storage for each block of the MLC flash memory device.

10. The method of claim 1, wherein the MLC flash memory device comprises a plurality of blocks of memory pages, and wherein at least one block of memory pages is set to operate in a MLC mode of operation and at least one other block of memory pages is set to operation in a SLC mode of operation.

11. A computer program product comprising a computer readable storage medium having a computer readable program stored therein, wherein the computer readable program, when executed by a controller of a multi-layer cell (MLC) flash memory device, causes the controller to:
control accesses to a block of memory pages in the MLC flash memory to be performed to the full block of memory pages in a MLC mode of operation;
determine whether a MLC retirement threshold has been met or exceeded by an operating characteristic of the block of memory pages;
switch, in response to detecting that the operating characteristic of the block of memory pages has met or exceeded the MLC retirement threshold, an operating mode associated with the block of memory pages from the MLC mode of operation to a single-level cell (SLC) mode of operation in which a sub-set of pages of the block of memory pages are utilized for access operations; and
control access operations to the block of memory pages in accordance with the SLC mode of operation in response to switching the operating mode of the block of memory pages from the MLC mode of operation to the SLC mode of operation.

12. The computer program product of claim 11, wherein the sub-set of pages of the block of memory pages that are utilized for access operations comprises least significant bit (LSB) pages of the block of memory pages, and wherein most significant bit (MSB) pages of the block of memory pages are not utilized for access operations while the MLC flash memory device is operating in the SLC mode of operation.

13. The computer program product of claim 11, wherein the computer readable program further causes the controller to:
determine whether a SLC retirement threshold has been met by the operating characteristic of the block of memory pages; and
retire the block of memory pages in response to the SLC retirement threshold being met, wherein the block of memory pages is not utilized for access operations in response to the block of memory pages being retired.

14. The computer program product of claim 11, wherein the sub-set of pages of the block of memory pages that are utilized for access operations while the MLC flash memory device is operating in the SLC mode of operation comprises a sub-set of pages that are furthest from a select gate at source end signal (SGS) connection of the block of memory pages relative to a second sub-set of pages of the block of memory pages.

15. The computer program product of claim 11, wherein the computer readable program causing the controller to control accesses to a block of memory pages in the MLC flash memory to be performed to the full block of memory pages in the MLC mode of operation further comprises causing the controller to:
create a high performance logical block from a first sub-set of pages of blocks of pages in the MLC flash memory;
create a low performance logical block from a second sub-set of pages of blocks of pages in the MLC flash memory;
direct access operations from a high performance application to the high performance logical block; and
direct access operations from a non-high performance application to the low performance logical block.

16. The computer program product of claim 15, wherein the first sub-set of pages of blocks of pages in the MLC flash memory comprises least significant bit (LSB) pages of the blocks of pages in the MLC flash memory, and wherein the second sub-set of pages of blocks of pages in the MLC flash memory comprises most significant bit (MSB) pages of the blocks of pages in the MLC flash memory.

17. The computer program product of claim 11, wherein the computer readable program further causes the controller to:
determine that a garbage collection operation on blocks of the MLC flash memory device is to be performed;
move valid pages of blocks of the MLC flash memory device to least significant bit (LSB) pages blocks of the MLC flash memory operating in a SLC mode of operation; and
responsive to completion of the moving of the valid pages, perform garbage collection on the blocks of the MLC flash memory device.

18. The computer program product of claim 11, wherein the operating characteristic of the block of memory pages comprises a number of erasure operations performed on the block of memory pages.

19. The computer program product of claim 11, wherein the computer readable program further causes the controller to switch an operating mode associated with the block of memory pages from the MLC mode of operation to a single-level cell (SLC) mode of operation at least by storing an indicator of a mode of operation of the block of memory pages in a block retirement state data structure storage of the MLC flash memory device, and wherein a separate indicator is stored in the block retirement state data structure storage for each block of the MLC flash memory device.

20. An apparatus comprising:
a multi-layer cell (MLC) flash memory; and
a controller coupled to the MLC flash memory, wherein the controller comprises logic configured to cause the controller to:
control accesses to a block of memory pages in the MLC flash memory to be performed to the full block of memory pages in a MLC mode of operation;
determine whether a MLC retirement threshold has been met or exceeded by an operating characteristic of the block of memory pages;
switch, in response to detecting that the operating characteristic of the block of memory pages has met or exceeded the MLC retirement threshold, an operating mode associated with the block of memory pages from the MLC mode of operation to a single-level cell (SLC) mode of operation in which a sub-set of pages of the block of memory pages are utilized for access operations; and
control access operations to the block of memory pages in accordance with the SLC mode of operation in response to switching the operating mode of the block of memory pages from the MLC mode of operation to the SLC mode of operation.
